(19) United States
(12) Patent Application Publication
(10) Pub. No.: US 2026/0302510 A1
(43) Pub. Date: Oct. 1, 2026

(54) MOTOR VEHICLE BATTERY PACK AND GAS DISCHARGE DEVICE

(71) Applicant: VALEO SYSTEMES THERMIQUES, Le Mesnil-Saint-Denis (FR)

(72) Inventors: Guillaume GARDERE, Le Mesnil-Saint-Denis (FR); Sergio DA-COSTA-PITO, Le Mesnil-Saint-Denis (FR); Enzo MITIDIERI, Le Mesnil-Saint-Denis (FR)

(73) Assignee: VALEO SYSTEMES THERMIQUES, Le Mesnil-Saint-Denis (FR)

(21) Appl. No.: 19/489,441

(22) PCT Filed: May 28, 2024
(86) PCT No.: PCT/EP2024/064655

§ 371 Date: Dec. 2, 2025

(30) Foreign Application Priority Data
Jun. 13, 2023 (FR) FR2306013

(51) Int. Cl. H01M 50/342; H01M 50/209; H01M 50/271

(52) U.S. Cl. CPC H01M 50/3425; H01M 50/209; H01M 50/271

(57) ABSTRACT

A motor vehicle battery pack includes a casing, which is configured to house electrical energy storage modules, and at least one cover able to cover the casing. The at least one cover includes an inner face positioned facing the casing. The battery pack includes at least one seal arranged between the inner face of the cover and the casing. At least one of the seal, casing and cover being configured to form at least one weakened area of the seal that is dimensioned to allow discharge of gases under a predetermined pressure or temperature of these gases.

The present invention lies in the field of motor vehicle batteries and relates more particularly to the field of safety devices for discharging the gases that can arise in the batteries in the event of thermal runaway of the electrochemical cells that make up these batteries.

Following a short circuit or an impact, an impaired electrochemical cell present in the battery back may overheat and the increase in temperature of this cell may cause hot fumes to be released and thermal runaway which propagates from cell to cell. In order to limit the deterioration of each of the cells and the risk of explosion which could result from this thermal runaway, there is a desire to discharge the gases present in the battery pack at the moment of thermal runaway, the gases needing to be discharged into zones that do not represent a risk to the health of passengers who need to evacuate the vehicle at this time or members of the emergency services who have come to help the passengers.

Currently, the devices used in motor vehicles to discharge the gases produced by the thermal runaway of battery cells consist of a valve disposed on a wall of the casing or of the cover of the battery pack, this valve being configured to trip at a certain pressure of the gases trapped within the battery pack.

These discharge devices that are known from the prior art have a number of drawbacks, however. A first drawback resides in the fact that the valves tend to open too late such that the temperature of the gases is high enough to damage the whole battery pack. Furthermore, the valves constitute large parts, this having the effect of increasing the size of the battery pack, whereas the bulk of the vehicle needs to be controlled. Moreover, the valves expel the fumes out of the battery pack in a random manner, thereby risking sending them into a zone in which passengers of the vehicle could be present.

There is currently a need to improve the configuration of the gas discharge device of a motor vehicle battery pack so as to reduce the dimensions of the battery pack and thus make it easier to integrate it into the vehicle while ensuring the safety of the passengers thereof.

The present invention falls within this context and provides a gas discharge device comprising one or more seals that respectively have a weakening zone configured, with the rest of the seal, to make the battery pack leaktight in a normal operating mode and to give way and allow the discharge of the fumes produced in the event of thermal runaway.

More particularly, the main subject of the present invention is a motor vehicle battery pack having a casing configured to accommodate electrical energy storage modules, and at least one cover that is able to cover said casing, the at least one cover comprising an internal face disposed facing the casing, the battery pack having at least one seal arranged between the internal face and the casing, the at least one seal and/or the casing and/or the cover being configured to form a gas discharge device with at least one weakening zone of the seal, designed to allow gases to be discharged under a given pressure or at a given temperature of these gases.

A battery pack is present in particular in electric or hybrid motor vehicles in order to supply the energy required for the propulsion of the vehicle. The battery pack has a rigid housing which accommodates a plurality of electrochemical cells that need to be protected against impacts. The casing has the purpose of mechanically protecting the electrochemical cells for storing and supplying electrical energy within the vehicle.

These electrochemical cells are disposed alongside one another against a bottom wall of the casing. In one embodiment, the bottom wall is opposite a first end of said casing that is intended to be covered by the at least one cover. According to different alternatives, the bottom wall may be formed in one piece with the casing or be formed by a second cover.

Generally, the cover may form one or the other of the walls of the battery pack, and, for example, be positioned laterally between an upper wall and a lower wall, with regard to the arrangement of the battery pack in the vehicle in relation to a vertical direction.

The casing is closed in a leaktight manner by a cover so as to prevent dirt or moisture from passing into said casing and having a negative effect on the operation of the electrochemical cells accommodated therein. It is therefore common practice to dispose seals between the casing and the cover closing the battery back in order to ensure the leaktightness of the latter.

The temperature of the electrochemical cells of the battery pack increases while they are in operation. Thermal regulation means, in particular having means for recirculating and/or spraying a dielectric cooling fluid, or means for indirect cooling using glycol water, or means for cooling involving recirculation and/or spraying of a glycol water fluid are present in the battery back in order to regulate the temperature of the cells in a standard operating mode. When the cells malfunction, and more particularly when the vehicle undergoes a violent impact and the integrity of the cells is affected, unusual overheating of the cells may occur and propagate step by step as a thermal runaway involving the presence within the battery pack of particularly hot gases at high pressure, which need to be discharged in order, in particular, to avoid the risk of an explosion.

The casing according to the invention, as presented, allows the discharge of these gases that are present in quantity during thermal runaway, such that it only needs to be implemented when a malfunction or an impact has occurred. This discharge takes place in this case via the weakening zone, which, according to the invention, is a zone of the seal that forms a discharge device. It is through this weakening zone that the gases can pass in order to be expelled from the battery pack when the discharge device has to come into action, that is to say, as mentioned, when a malfunction or an impact has occurred. Therefore, according to the invention, there is a seal which ensures leaktightness during normal operation, in particular when the pressure or the temperature of gases within the battery pack is normal, i.e. below a given threshold value, and a part of which, namely the weakening zone, is able to adopt a second configuration under the effect of a pressure or a temperature that exceeds this threshold value, in order to allow gases to be discharged.

This weakening zone is formed via a part of the battery pack which has a different function during normal operation, namely the seal, such that functional integration is achieved, making it possible to do without an additional part or piece of equipment in order to achieve the discharge function, this representing an economic benefit.

According to an optional feature of the invention, the weakening zone is formed by a local deformation of the at least one seal.

A local deformation is understood to be a modification in the shape and/or the dimensions of the seal over a minimal portion thereof, such that the shape and/or the dimensions of the weakening zone are different than those of the rest of the seal.

According to an optional feature of the invention, the at least one seal is formed from a material injection-molded over the perimeter of the battery pack, on a face of the casing and/or of the cover.

According to an optional feature of the invention, said material is a polyurethane foam and/or a silicone foam.

According to an optional feature of the invention, the at least one seal is an elastomer seal, placed in one piece between the casing and the cover.

According to an optional feature of the invention, said seal is placed in a groove formed in the thickness of the casing and/or of the cover.

The groove is a peripheral slot in the casing and/or the cover, meaning that it extends continuously all around the housing in which the cells of the battery pack are accommodated. In cross section, the groove has a shape which is substantially similar to the shape of the portion of the seal that is accommodated in the groove. One groove can be formed in the casing and another groove can be formed in the cover in order to each receive a portion of the seal.

According to an optional feature of the invention, the weakening zone of the at least one seal extends over a distance of around 1 to 50% of the peripheral dimension of the seal, preferably 1 to 30%, in particular 5% to 25%.

These values represent a good compromise between the need to have a sufficient extension distance of the weakening zone to discharge a significant quantity of gases in the event of a malfunction or impact that is able to bring about thermal run away and the need to have a seal which reliably performs its leaktightness function during standard operation.

According to an optional feature of the invention, the groove for receiving the at least one seal has a larger cross section in the weakening zone than that of the rest of the groove.

In the weakening zone, the groove has a larger cross section than the cross section of the rest of the groove in which the rest of the seal is inserted. This larger dimension may equally be a width, in the plane of the casing or of the cover from which the seal emerges, or a depth in the material of the casing or the cover. Thus, the seal in the region of the weakening zone can be displaced within the groove when the pressure of the gases, and in particular of the hot gases present within the battery pack in the event of a malfunction or impact, is higher than a threshold value, allowing easier passage of the gases.

According to another feature, the at least one cover and/or the casing has a bearing zone which is in contact with the at least one seal interposed between this cover and the casing, the bearing zone having a relief, in particular a slot, that is able to cooperate with the at least one seal in its weakening zone.

The bearing zone faces the seal and the relief more particularly faces the weakening zone of the seal.

The relief may be formed in one piece in the casing or be attached to the internal face of the cover. The relief may be, for example, a boss. When the casing is closed by virtue of the cover, the relief arranged in the latter can, in this way, more deeply press a local zone of the seal disposed facing the relief and corresponding to the weakening zone. This results in a compression ratio of the seal in the weakening zone which is different, and more particularly higher, at this specific point of the seal compared with the rest of the seal.

It will be understood that a relief in the form of a boss makes it possible to locally bring about a compression ratio higher than the standard compression ratio applied to the rest of the seal, this having the effect of locally weakening the seal and creating a weakening zone that is more able to subsequently deform under a high temperature or pressure of gases during a thermal runaway.

Alternatively, the relief may be a cavity forming a material clearance in the thickness of the cover, such that more space is left locally for the seal when the cover is attached to the casing. This causes a compression ratio that is also different, but in this alternative lower at this specific point of the seal, thereby making it possible, here too, to create a weakening zone.

It will be understood that a relief in the form of a cavity makes it possible to locally bring about a compression ratio lower than the standard compression ratio applied to the rest of the seal, this having the effect of creating a weakening zone in which the seal is again able to be compressed under the effect of a pressure or a temperature of the gases during a thermal runaway and, consequently, to allow these gases to pass between the casing and/or the cover and the seal compressed in the weakening zone.

According to an optional feature of the invention, the weakening zone of the at least one seal has a compression ratio lower than the compression ratio of the rest of the seal.

This difference in the compression ratio of the weakening zone can be achieved in particular by a cavity formed in the cover, as mentioned, by a dimension of the peripheral groove in the casing which locally has, in the weakening zone, dimensions larger than those of the rest of the groove, or by a heterogeneous structural composition of the material, for example a two-material design of the seal, which allows a local difference in compression ratio under the same pressure load on the cover of the casing.

According to an optional feature of the invention, at least two seals are interposed between the casing and the at least one cover, on the perimeter of the casing, each seal being offset radially from the adjacent seal along a first radial direction, each seal having a weakening zone, the weakening zone arranged in a first seal being in particular offset angularly with respect to the weakening zone arranged in a second seal.

The concept of radial and angular offset should be understood broadly, independently of the overall shape of the seals in the contact plane between the casing and cover. In particular, the concepts of radial and angular offset do not necessarily mean a circular overall shape of the seal, but can be understood with a substantially rectangular overall shape. The concept of radial offset is understood with regard to the radial direction extending from the interior to the exterior of the battery pack, through the walls of the casing.

A radial offset should thus be understood as involving the presence of a first seal disposed on the perimeter of the casing as close as possible to the electrochemical cells accommodated in the battery pack and the presence of a second seal disposed on the same perimeter more distally with respect to said cells, in other words toward the exterior of the casing.

The concept of angular offset is understood with regard to the peripheral path around the cells of the battery packs, on the end faces of the walls of the casing that are intended to be in contact with the cover.

Thus, the angular offset means that the first weakening zone arranged in the first seal is offset such that it is not disposed facing the second weakening zone arranged in the second seal.

This configuration allows the discharge of the gases to be regulated and optimized. An abnormal temperature or pressure of the gases during a thermal runaway will cause the first weakening zone arranged in the first seal located closest to the electrochemical cells to give way, the first weakening zone being able to be located on the periphery of the first seal as close as possible to the point at risk of being hottest within the battery pack. The gases will then circulate between the two seals until they reach the second weakening zone arranged in the second seal. This second weakening zone, for its part, is located on the periphery of the second seal as close as possible to the zone which has been identified as being a safe zone for the discharge of the gases at high pressure and high temperature, that is to say a zone where occupants of the vehicle or members of the emergency services are not meant to be located in the event of thermal runaway and evacuation of or intervention in the vehicle.

According to an optional feature of the invention, a motor vehicle battery pack has at least one casing, a cover configured to cover a first end edge of the casing, and an additional cover for covering a second end edge of the casing opposite to the first end edge, said battery pack having a gas discharge device as mentioned above arranged between the casing and the cover, and a gas discharge device as mentioned above arranged between the casing and the additional cover.

The gas discharge device as mentioned above is arranged between the casing and the cover and/or the additional cover. The presence of a discharge device arranged between the casing and each cover thus makes it possible to improve the performance in terms of gas discharge of the battery pack. In the following text, the passages that mention the cover and the additional cover can be applied with the positions of these two elements interchanged.

Further features, details and advantages of the invention will become more clearly apparent from reading the following description, and from studying exemplary embodiments given by way of nonlimiting indication, with reference to the appended drawings, in which:

FIG. 1 schematically illustrates a motor vehicle battery pack equipped with a discharge device having a weakening zone according to one embodiment of the invention;

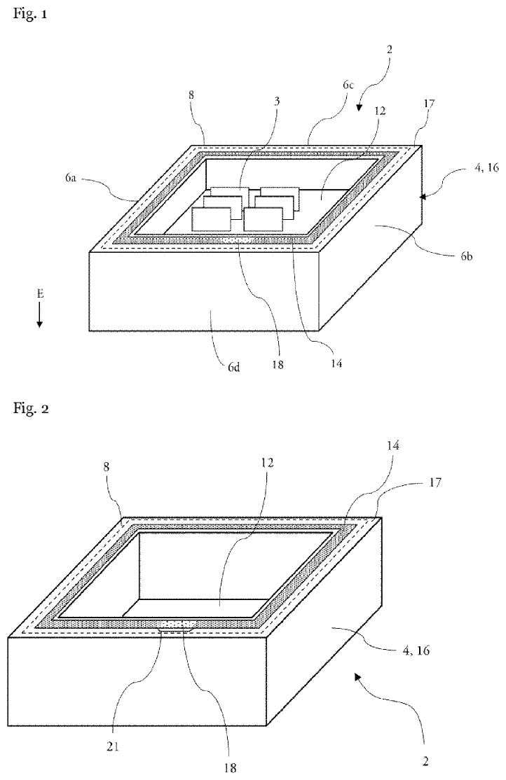

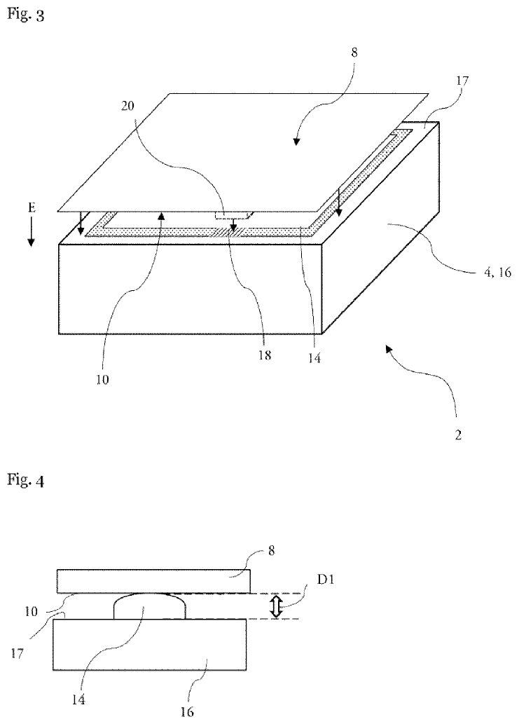

FIG. 2 schematically illustrates a battery pack equipped with the discharge device according to the invention, according to a first alternative;

FIG. 3 schematically illustrates a battery pack equipped with the discharge device according to the invention, according to a second alternative;

FIG. 4 schematically illustrates, in section, a portion of a battery pack in which the discharge device is in a standard configuration;

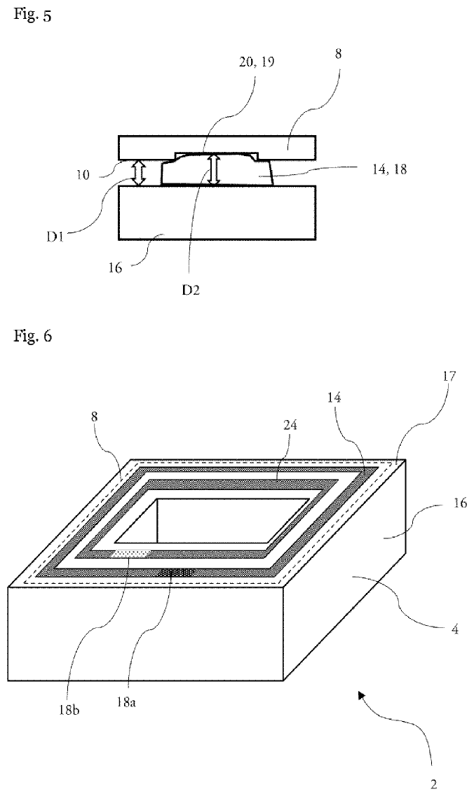

FIG. 5 schematically illustrates, in section, a different portion of the battery pack illustrated in FIG. 4, this figure illustrating more particularly the weakening zone of the discharge device;

FIG. 6 schematically illustrates a motor vehicle battery pack equipped with a discharge device according to a second embodiment. The features, variants and different embodiments of the invention can be combined with one another, in various combinations, as long as they are not mutually incompatible or mutually exclusive. It will be possible, in particular, to imagine variants of the invention that comprise only a selection of the features described below, independently of the other features described, provided that this selection of features is sufficient to confer a technical advantage and/or to distinguish the invention from the prior art.

As a reminder, the invention relates to a battery pack in which a weakening zone is arranged in a seal in order to allow the discharge of the gases that result from a thermal runaway of the electrochemical cells of this battery pack, this weakening zone also needing to ensure the leaktightness of the battery pack during normal operation.

FIG. 1 illustrates a battery pack 2. The battery pack 2 has a casing 4 which is formed by a plurality of walls and has the function of protecting the electrochemical cells 3 of the battery pack, these electrochemical cells allowing the storage and supply of electrical energy. These electrochemical cells 3 are disposed against a bottom wall 12 of the casing. The casing is in this case in the form of a rectangular parallelepiped, with walls that are parallel in pairs 6a, 6b and 6c, 6d and form a frame 16. The frame 16 has a first end wall 17 of the casing 4, which is arranged opposite to the bottom wall 12 and which delimits an opening of the casing through which the electrochemical cells 3, some of which are shown in FIG. 1 without the number thereof being representative here, are inserted into the housing formed by the casing. The first end edge 17 is able to be covered by a cover 8 indicated by dashed lines in FIGS. 1 and 2 in order to reveal the interior of the casing and the arrangement of the discharge device associated with the battery back according to the invention. More specifically, the cover 8 closes the casing by bearing on the first end edge 17, around the entire perimeter of the frame 16, along a stacking direction E. The cover 8 comprises an internal face 10 disposed facing the frame 16 and in this case the bottom wall 12. The first end edge 17 of the frame 16 is a flat, peripheral surface of the casing 4 that is intended to face the internal face 10 of the cover 8.

Alternatively, the first end edge 17 is opposite to a second end edge of the frame 16, to which an additional cover can be affixed in order to form the bottom wall 12. In the following text, the description given for the means for sealing and gas discharge in the event of thermal runaway for the cover 8 and the first end edge 17 could be applied in the same way to the additional cover and to the second end edge.

It will be understood here that the cover can be affixed to the upper part of the casing, specifically against the first end edge 17, or be affixed to the lower part thereof, specifically against the second end edge of the frame 16, which is referred to as the additional cover in this second configuration. Alternatively, the cover 8 may form a side wall of the casing 4. Arranged between the frame 16 and the internal face 10 of the cover 8 is a seal 14. The seal 14 is mainly configured to ensure, in a standard operating mode, the leaktightness of the battery pack 2 and thus to protect the electrochemical cells from the dirt and moisture that are liable to pass into the latter. The leaktightness of the battery pack also makes it possible to maintain the effectiveness of the cooling means for the electrochemical cells within the battery pack 2, in particular by avoiding the leakage of dielectric cooling fluid or glycol water. It will be understood here that the seal 14 is arranged between the internal face 10 of the cover 8 and the frame 16 once the electrochemical cells are accommodated within the casing 4 and the cover 8 has been affixed to the frame 16 forming this casing 4.

The seal 14 may be placed on a flat face of the first end edge 17 of the frame, in particular using a robot configured to inject-mold a fluid material on a receiving zone for the seal. By way of example, the seal may be silicone or polyurethane foam injection-molded directly on the frame 16 before the cover is folded down on this frame.

Alternatively, the seal 14 may be placed in a groove 21 arranged in the internal face 10 of the cover 8 or in the frame 16, in particular when the seal 14 is formed by an elastomer seal of predefined shape, which fills the groove around the entire perimeter of the frame 16.

According to the invention, the seal 14 comprises a weakening zone 18. This weakening zone 18 is a local portion of the seal 14, which exhibits a difference compared with the rest of the seal, this difference allowing the weakening zone to provide the leaktightness function of the seal in a standard operating mode and to adopt a different configuration than the rest of the seal in an impaired operating mode, in particular when the battery pack undergoes thermal runaway, for example after the vehicle has suffered an impact.

This difference in the weakening zone compared with the rest of the seal may, in particular, be a different structural configuration, through the presence of a different material in a seal made of two materials, or caused by a different compression ratio in the weakening zone, for example. The difference in the weakening zone may also consist of different dimensions than those of the rest of the seal 14.

This weakening zone 18 is configured in particular to adopt a second configuration allowing gases to be discharged from the battery pack under the effect of an abnormal temperature and/or pressure of the gases produced by the thermal runaway of the electrochemical cells 3 during a malfunction of the battery pack, for example after the vehicle has suffered an impact.

As has been mentioned, the weakening zone 18 remains in its original configuration when the pressure and the temperature of the gases within the battery pack are in normal ranges of values, allowing the seal as a whole to maintain its leaktightness function. Conversely, when the pressure of the gases present inside the battery pack is above the pressure threshold considered normal, and/or when the temperature of the gases present inside the battery pack is above the temperature threshold considered normal, the weakening zone 18 adopts another configuration, and in particular shifts or changes shape and/or size, allowing the gases present in the battery pack to pass out of the battery pack. It will be understood here that the weakening zone 18 has a dual function, both that of providing leaktightness and that of discharging the gases. The temperature or pressure threshold above which the weakening zone adopts a second configuration allowing the gases to be discharged from the battery pack may be around 200 mbar to 400 mbar. These thresholds are defined in particular to ensure the safety of the occupants of the vehicle and members of the emergency services and to make it possible to avoid an explosion within the battery pack.

As has been mentioned, an additional seal, similar to the seal 14, could be disposed on the additional cover intended to cover the second end edge of the frame 16 in order to provide leaktightness at this second end edge.

The weakening zone 18 is located on the perimeter of the seal at a specific location to allow the gases to be discharged safely, in other words at a location where the gases are directed away from the passengers of the vehicle in which the battery pack 2 is integrated.

According to an alternative that is not shown here, the seal 14 may have several weakening zones 18, provided that each weakening zone is located on the perimeter at a specific location allowing the gases to be discharged safely.

In order to increase the quantity of gases discharged in the event of thermal runaway, the extension distance of the weakening zone 18 with respect to the peripheral dimension of the seal 14 may be lengthened, but the seal should not be weakened over too great a distance in order that it can maintain its integrity and its leaktightness function in a standard operation mode of the vehicle and of the battery pack. By way of example, a weakening zone 18 may extend over a distance of around 1 to 50% of the peripheral dimension of the seal 14, preferably 1 to 30%, in particular 5% to 25%.

FIG. 2 illustrates one of the exemplary embodiments of the weakening zone 18, which in this case is formed by the cooperation of the seal 14 with a groove for receiving the seal, the groove having at least one dimension which is locally increased, in the weakening zone.

In other words, the zone of the seal that is intended to be the weakening zone 18 is disposed in a portion of a groove 21 which has a cross section with a size larger than the size of the cross section of the rest of the groove in which the rest of the seal 14 is disposed. In the example illustrated, the portion of the groove 21 that is in the weakening zone has a radial dimension, that is to say a dimension along a direction from the inside of the battery pack to the outside of the battery pack, passing through a wall of the frame 16, which is greater than the corresponding dimension of the seal. It will be understood, without departing from the context of this exemplary embodiment, that it is the depth, i.e. the dimension along the abovementioned stacking direction E, of this portion of the groove which could be enlarged.

At the location at which the dimension of the groove is larger, that is to say in the weakening zone, the seal 14 has more space to expand during its compression by the closure of the cover and the compression ratio of the seal is locally lower than that of the rest of the seal. The weakening zone 18 of the seal may, in this way, move substantially in its groove portion under an abnormal temperature and/or pressure of the gases so as to allow the latter to pass through more easily when a thermal runaway of the electrochemical cells 3 occurs.

It will be understood that, in a standard configuration, i.e. with a pressure of the gases that does not challenge the original shape of the compressed seal, the seal as a whole, and in particular the weakening zone, extends so as to entirely fill the groove and ensure its leaktightness function.

FIG. 3 illustrates another exemplary embodiment of the weakening zone 18. In this example, the weakening zone 18 is produced by a local deformation of the seal 14.

This local deformation is achieved by the presence on the cover, in particular on the internal face of the cover, of a boss forming a relief 20. More particularly, this relief 20 is disposed in the bearing zone of the cover, that is to say in the peripheral zone on the internal face of the cover, which is intended to come into contact with the first end edge 17 and with the seal. The purpose of this type of relief 20 is to more deeply press the portions of the seal 14 facing the relief 20 when the cover 8 is brought into contact with the casing and in particular with the first end edge 17 of the frame 16 in order to create a weakening zone 18 depicted in a hatched manner in FIG. 3. It will be understood here that the presence of the relief 20 exerts, on the corresponding portion of the seal, that is to say the weakening zone 18, a compression ratio which is higher than the standard compression ratio applied to the rest of the seal 14. This high compression ratio contributes to weakening the seal in proportions such that the occurrence of a gas temperature or pressure higher than a threshold value, in particular in the event of a thermal runaway, is able to cause the seal to give way in the weakening zone.

The boss forming a relief 20 may have a shape that is rectangular, round or any other shape, provided that, in this alternative, it protrudes enough to locally ensure a compression ratio on the seal 14 which goes beyond the normal compression ratio applied to the rest of the seal.

FIGS. 4 and 5 illustrate local portions of a battery pack having a discharge device according to one exemplary embodiment of the invention, respectively showing a view in section of the seal 14 between the cover 8 and the frame 16 of the casing in a zone away from the weakening zone (FIG. 4) and a view in section of the seal 14 between the cover 8 and the frame 16 of the casing in the weakening zone 18. These figures illustrate an exemplary embodiment of the weakening zone, by the difference in the compression ratio applied to the seal from one zone of this seal to the other.

FIG. 4 illustrates a local portion in which the compression ratio of the seal is a standard compression ratio, applied when the cover 8 is folded down on the casing. This compression ratio is applied to the whole of the seal 14 except for in the weakening zone 18. The cover 8 is brought into contact with the frame 16 at a distance D1 from the first end edge 17 so as to compress the seal 14 with a standard compression ratio of between 40% and 60%.

FIG. 5 illustrates the weakening zone, in which the compression ratio of the seal is lower than the standard compression ratio, in particular on account of the presence of a cavity that locally leaves more space for the seal to expand when the cover is affixed to the casing.

More particularly, the cavity forms a relief 19 formed in the thickness of the cover 8. Here too, the relief 19 is disposed in the bearing zone of the cover, that is to say in the peripheral zone on the internal face of the cover, which is intended to come into contact with the first end edge 17 and with the seal. As can be seen in this FIG. 5, in this weakening zone, the whole cover 8 is at the same distance D1 from the frame 16, but the cavity forming a relief 19 provides a clearance distance D2 which is greater than this distance D1, such that the seal has more space to expand. This type of relief thus brings about a compression ratio of the seal 14 which is lower than the standard compression ratio, and which may, in particular, be between 20% and 30%, thereby forming the weakening zone 18. It will be understood that this weakening zone 18, being less compressed than its properties allow, is still able to be compressed under the effect of a pressure or a temperature of the gases during a thermal runaway, this having the consequence of allowing these gases to pass between the casing 4 and/or the cover 8.

FIG. 6 shows a second embodiment of the invention. This second embodiment differs from the first embodiment in that the gas discharge device comprises two seals 14, 24 arranged between the internal face 10 of the cover 8 and one and the same end edge of the frame 16 of the casing 4.

A first seal 14 forms an inner seal, which is disposed on the first end edge 17 of the frame 16 of the casing 4 as close as possible to the electrochemical cells 3, and a second seal 24 forms an outer seal, which is also disposed on the first end edge 17 and which is offset radially toward the outside of the frame with respect to the inner seal. The first seal 14 comprises a first weakening zone 18a. The second seal 24 comprises a second weakening zone 18b. Each of these weakening zones may be produced in accordance with one of the abovementioned exemplary embodiments of the invention, without this limiting the invention, provided that each seal has a weakening zone that is able to adopt a configuration participating in the leaktightness function, that is to say impermeable to the passage of gases, in particular, during standard operation, and to adopt a second configuration allowing the passage of gases at high pressure and/or high temperature in the event of a thermal runaway within the battery pack.

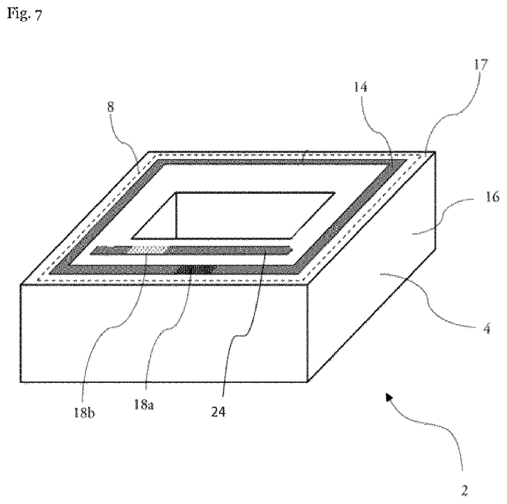

FIG. 7 shows a third embodiment of the invention. This third embodiment differs from the second embodiment in that the gas discharge device comprises two seals 14, 24 arranged between the internal face 10 of the cover 8 and one and the same end edge of the frame 16 of the casing 4, but the first seal (14) peripherally surrounds the whole of the perimeter of the battery pack (2), of the face of the casing (4) and/or of the cover (8), while the second seal (24) is present on a partial portion of the perimeter of the battery pack (2), of the face of the casing (4) and/or of the cover (8).

Thus, doubling the seal only in the vicinity of the weakening zone makes it possible to ensure the leaktightness of the zone in a normal situation, in spite of the presence of the weakening zone (18).

In an alternative that is not shown here, the inner seal and/or the outer seal could respectively have several weakening zones 18.

The first weakening zone 18a arranged on the first seal 14 and the second weakening zone 18b arranged on the second seal 24 are offset angularly so as not to face one another. In other words, the weakening zones of each of the seals do not radially face one another and the gases discharged from the inside of the battery pack to the outside have to follow a meandering path in order to exit the battery pack.

The first weakening zone 18a arranged in the first seal 14 may be a zone located at a specific location, and in particular as close as possible to a location where an increase in temperature and/or pressure of the gases present in the battery pack can be identified early. The second weakening zone 18b arranged in the second seal 24 may be a zone located at a location identified as having no impact on the safety on the passengers of the vehicle during the discharge of the gases. Thus, the high-pressure and/or high-temperature gases cause the first weakening zone 18a to give way or deform in order for them to pass through the first seal, then they flow between the cover 8 and the frame 16 between the two seals until they reach the second weakening zone 18b, in order to cause it to give way in turn, thereby allowing the gases to be discharged from the battery pack 2 without endangering the passengers of the vehicle.

In this context, it is possible to provide two different temperature or pressure thresholds, respectively associated with one of the two seals. By way of nonlimiting example of the invention, these threshold values, above which the weakening zone adopts a second configuration allowing the gases to be discharged from the battery pack, may be around 200 mbar to 300 mbar for the first weakening zone 18a of the first seal 14 and around 400 mbar and above for the second weakening zone 18b of the second seal 24.

As has just been described, the invention achieves its stated aims by providing a device for discharging high-pressure and/or high-temperature gases, which is intended to avoid a risk of explosion in a battery pack in the event of thermal runaway and which does not require the addition of valves, which are expensive and bulky, to a battery pack. The discharge device according to the invention locally modifies the properties of the seal provided originally on the battery pack for conventional leaktightness functions, so as to incorporate a function of discharging the high-pressure and/or high-temperature gases into a part that is already provided. In this way, space is saved and the costs for achieving this function are reduced, by forming, in the seal, a weakening zone that is able to give way or to be modified under extreme conditions, in particular in the event of a violent impact suffered by the vehicle and a risk of explosion, allowing the gases to pass out of the vehicle.

1. A motor vehicle battery pack having a casing configured to accommodate electrical energy storage modules, and at least one cover that is able to cover said casing, the at least one cover comprising an internal face disposed facing the casing, the battery pack having at least one seal arranged between the internal face of the cover and the casing, the at least one seal and/or the casing and/or the cover being configured to form at least one weakening zone of the seal, designed to allow gases to be discharged under a given pressure or at a given temperature of these gases.

2. The battery pack as claimed in claim 1, wherein the at least one seal has a local deformation, in particular a shape and/or dimensions different than those of the rest of the seal, so as to form the weakening zone

3. The battery pack as claimed in claim 1, wherein the at least one seal is formed from a material injection-molded over the perimeter of the battery pack, on a face of the casing and/or of the cover.

4. The battery pack as claimed in claim 3, wherein said material is a polyurethane foam and/or a silicone foam.

5. The battery pack as claimed in claim 1, wherein the at least one seal is an elastomer seal, placed in one piece between the casing and the cover.

6. The battery pack as claimed in claim 1, wherein the weakening zone of the at least one seal extends over a distance of around 1 to 50% of the peripheral dimension of the seal, preferably 1 to 30%, in particular 5% to 25%.

7. The battery pack as claimed in claim 1, wherein said seal is placed in a groove formed in the thickness of the casing and/or of the cover.

8. The battery pack as claimed in claim 7, wherein the groove for receiving the at least one seal has a larger cross section in the weakening zone than that of the rest of the groove.

9. The battery pack as claimed in claim 1, wherein the at least one cover and/or the casing has a bearing zone which is in contact with the at least one seal interposed between this cover and the casing, the bearing zone having a relief, in particular a slot, that is able to cooperate with the at least one seal in its weakening zone.

10. The battery pack as claimed in claim 1, wherein the weakening zone of the at least one seal has a compression ratio lower than the compression ratio of the rest of the seal.

11. The battery pack as claimed in claim 1, wherein at least two seals are interposed between the casing and the at least one cover, on a frame of the casing, each seal being offset radially from the adjacent seal along a first radial direction, each seal having a weakening zone, the weakening zone arranged in a first seal being in particular offset angularly with respect to the weakening zone arranged in a second seal.

12. The battery pack as claimed in claim 2, wherein the at least one seal is formed from a material injection-molded over the perimeter of the battery pack, on a face of the casing and/or of the cover.

13. The battery pack as claimed in claim 2, wherein the at least one seal is an elastomer seal, placed in one piece between the casing and the cover.

14. The battery pack as claimed in claim 2, wherein the weakening zone of the at least one seal extends over a distance of around 1 to 50% of the peripheral dimension of the seal, preferably 1 to 30%, in particular 5% to 25%.

15. The battery pack as claimed in claim 2, wherein said seal is placed in a groove formed in the thickness of the casing and/or of the cover.

16. The battery pack as claimed in claim 2, wherein the at least one cover and/or the casing has a bearing zone which is in contact with the at least one seal interposed between this cover and the casing, the bearing zone having a relief, in particular a slot, that is able to cooperate with the at least one seal in its weakening zone.

17. The battery pack as claimed in claim 2, wherein the weakening zone of the at least one seal has a compression ratio lower than the compression ratio of the rest of the seal.

18. The battery pack as claimed in claim 2, wherein at least two seals are interposed between the casing and the at least one cover, on a frame of the casing, each seal being offset radially from the adjacent seal along a first radial direction, each seal having a weakening zone, the weakening zone arranged in a first seal being in particular offset angularly with respect to the weakening zone arranged in a second seal.

19. The battery pack as claimed in claim 3, wherein the weakening zone of the at least one seal extends over a distance of around 1 to 50% of the peripheral dimension of the seal, preferably 1 to 30%, in particular 5% to 25%.

20. The battery pack as claimed in claim 3, wherein said seal is placed in a groove formed in the thickness of the casing and/or of the cover.
